(19) United States
(12) Patent Application Publication
(10) Pub. No.: US 2011/0149398 A1
(43) Pub. Date: Jun. 23, 2011

(54) Instant messaging method-much faster than light communication

(76) Inventor: Donald Wortzman, Carmel, NY (US)

(21) Appl. No.: 12/807,712

(22) Filed: Sep. 13, 2010

Related U.S. Application Data
(60) Provisional application No. 61/284,404, filed on Dec. 18, 2009.

(51) Int. Cl. G02B 27/10

(52) U.S. Cl. 359/577

(57) ABSTRACT

Described is a means for communication, enabling message transmission faster than the speed of light between two separated locations. A photon source feeds a splitter, which allows a single photon to split between flowing down the left input side and the right output side. On the left, the photon enters a phase splitter, which produces an in-phase and inverted phase signal. With the delay switch at zero delay, both signals arrive together at the combiner with opposite phase, canceling each other out. With the delay switch set to half a wavelength, no cancellation results and the signal passes unabated through the combiner. In this mode, approximately, fifty percent of the photons register at each detector, which are equidistant from the photon source. In the former mode, (delay switch set to zero) much more of the photons appear at the output detector, and no signal appears at the input detector.

Consider the simplified schematic that follows. Because the optical switch is very close to the input side detector, only at the last instant of time does the photon decide to flow to the right-side output detector, with either certainty or just with 50% probability, depending on the setting of the delay switch. Varying the probability of the outcome by increasing the input voltage can be delayed to the point where the photons have already traveled a long distance. Consequently, in the time it would ordinarily take a photon to travel the short distance from the switch to the left-side detector, up to 50% of the photons can be diverted from the left input detector to the right-side output detector, a long way from the delay switch. However, it takes many photons to insure that the change has taken place, since no single photon can be counted on to make the switch.

Claims priority of Provisional Patent Application—Instant Messaging Method: Much Faster Than Light Communication U.S. 61/284,404 by Donald Wortzman, filed on Dec. 18, 2009.

### CROSS REFERENCES

1. Double slit experiment, discussion and explanation: The Gyroverse, second edition, by Donald Wortzman, published by AuthorHouse Publishing, Dec 2004, pages 137-140

2. John Archibald Wheeler's delayed choice experiment, discussion and explanation: The Gyroverse, second edition, by Donald Wortzman, published by AuthorHouse Publishing, Dec 2004, pages 202-208

3. Nicolas Gisin's entanglement EPR experiment, discussion and explanation: The Gyroverse, second edition, by Donald Wortzman, published by AuthorHouse Publishing, Dec 2004, pages 259-262.

4. Bells Inequality discussion and explanation: The Gyroverse, second edition, by Donald Wortzman, published by AuthorHouse Publishing, Dec 2004, pages 257-258.

5. Electro-optic delay switch: For example, made using a Lithium Niobate Crystal (LiNbO₃) variable delay switch.

6. The Gyroverse, third edition, by Donald Wortzman, published by CreateSpace, 2010

### BACKGROUND OF THE INVENTION

It is universally accepted that communication faster than light-speed is not possible. Although it has not been proven, it nevertheless has not been reportedly done. However, to be described is a communication mechanism that does do it, much faster than the speed of light.

It has been shown that entangled particles can correlate with each other much faster than the speed of light. Even though they are correlated, transmitting messages using this correlation is not possible, according to orthodox theory. The reason is that all entanglement only seems possible while the particles are in random state. The mere attempt to constrict the particles to any non-random subset seems to destroy their entangled state. While no one has reportedly demonstrating faster-than-light information transmission using this principle, it is not clear that it is not possible.

A related action-at-a-distance phenomenon to entanglement is dispersement, the ability of a single atomic particle to be dispersed over large distances. An example of this phenomenon is the double-slit experiment, where a single photon appears to pass simultaneously through two slits. While this demonstrates the principle, among other deficiencies, the slits need be too close together to be useful in effecting communication. Another germane experiment was proposed by John Wheeler³, a colleague of the previous turn of the century greats. It was a cosmic scale version of the double slit experiment² that currently can only be explained by assuming the past can be altered, not just a fraction of a nanosecond, but millions of light-years. While his experiment has practical problems, and was never done, a bench-top version of it was successfully demonstrated. Nevertheless, this method is also not amenable for beyond light-speed communication. Very recently, an EPR Paradox (or Einstein-Podolsky-Rosen paradox) embodiment was proposed and tested by Nicolas Gisin, at Geneva University, which demonstrated entanglement over a seven-mile span. However, this arrangement also could not be used for faster-than-light communication.

This disclosure builds on these ideas, but gets around their limitations, and can effect much faster-than-light information transfer. Defined is a delayed-choice arrangement, where the alternate paths terminate far from each other.

### DESCIPTION OF DRAWINGS

FIG. 1 is a schematic of the Delayed-Choice-EPR instant messaging embodiment. The input (18) is at the sending location. The output (25) is at the receiving location, many miles away. The photon source (11) is in the middle between the sending (18) and receiving (25) locations.

FIG. 2 is the detailed enlargement of the Phase Splitter (16).

### DESCIPTION OF INVENTION

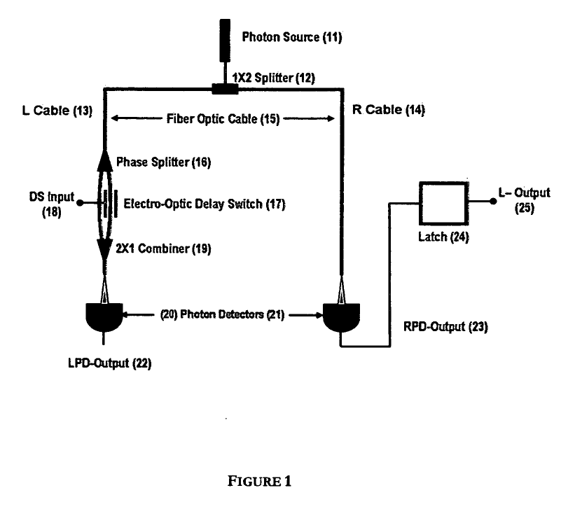

The schematic to achieve this almost instant messaging is shown in FIG. 1. Monochromatic light (note that the terms light and photon are used interchangeably depending whether its wave or particle attributes are being emphasized) originates at the photon source. Although it is not necessary, assume for discussion purposes that the light-beam is a low enough intensity so that the photons are emitted individually.

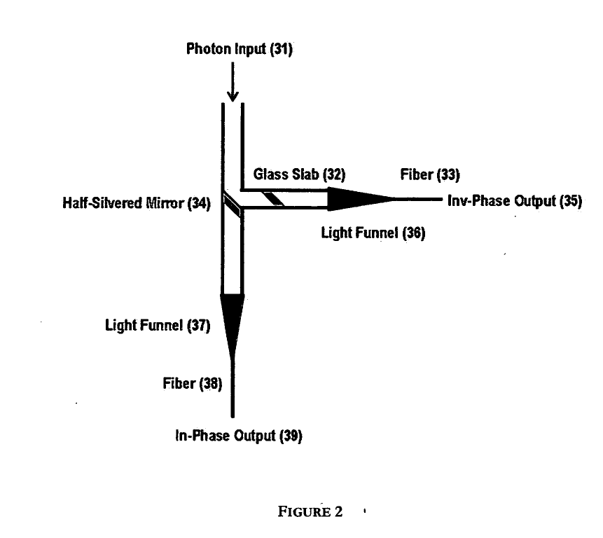

The first 1X2 splitter (12) is symmetrical so that half the photon beam goes through the slightly longer (output beam) fiber optic R Cable (14) and the other half (input beam) goes through the L Cable (13). The beam going left meets another juncture, a beam modifier, comprising a phase splitter (16), followed by an electro-optic delay switch (17) in parallel with a short fiber optic cable segment, then followed by a 2X1 combiner. The phase splitter produces two simultaneous beams, 180 degrees out of phase with each other. Its operation is described in detail later with the help of FIG. 2. After the phase splitter, on the left is a fiber optic cable segment. On the right, the beam goes through an electro-optic delay switch (17). The voltage on the electro-optic delay switch modulates the fiber's index of refraction. Increasing the voltage increases the index, so that at some voltage, the delay increase reaches a half wavelength. At its lower level, the added delay is zero. Assume initially the input voltage (18) to the electro-optic delay switch (17) is at its lower level, reducing the delay to zero. With both parallel paths equidistance, the photon beams arrive at the 2X1 combiner (19) simultaneously out-of-phase with each other, destructively interfering, causing almost all of the photons to appear at the right output detector (21). The output voltage of the left detector is at its low voltage, and the right detector is at its high voltage, setting the output latch (24). Consequently, the voltage out (25) of the latch is at its lower level. Summarizing, when the input voltage (18) is at its lower level, the output (25) of latch (24) is at its lower level.

If the electro-optic delay switch input (18) is subsequently set to its upper level, the delay through that juncture is delayed half a wavelength. Hence, the light wave meets at the 2X1 combiner (19) at different times and constructively interferes, so half the light signal passes to the left detector, generating half voltage output at the left photon detector output (22). Since half the photons enter the left detector (22), only half arrive at the right detector, lowering the output voltage (23) at that detector. The smaller output voltage at (23) flips the latch (24), setting its output (25) to its upper level. In summary, when the optical delay switch's input voltage (18) is at its upper level, the output voltage (25) is also at its upper level.

Assume that both detectors are about equidistant (R Cable (14) slightly longer than L Cable (13)) from the photon source, but miles from each other. Also, assume that the electro-optic delay switch is less than a meter from the left detector (22). Then, neglecting the switching, and other circuit delays, once the switch is thrown from constructive to destructive interference, almost all of the photons upstream from the switch will only be detected at the right detector, almost doubling its output. When the switch is thrown the other way, the right detector goes back to the original output. A photon that is centimeters from the input switch will then appear or disappear at the right detector, miles away, in the time it takes light to travel about a meter. The result is communication, much faster than light-speed. While for clarity, the description assumed that the photons were released one-at-a-time, the restriction was not used and is not necessary. Since this method alters only the probability of taking each path, many photons are needed to get the voltage change. Therefore, the intensity of light needs to be high enough, and the response of the detector fast enough, so that the time for a large number of photons to switch the detector is insignificantly short.

In addition, there are several variations of the setup that can be made.

1) Another delay switch with phase splitter and combiner could be placed on the right side, and another latch placed on the left side, making the arrangement symmetrical, allowing messages to be sent in both directions.

2) A duplicate arrangement can face the opposite direction, effecting two way communication.

3) While orthodox theory says that there is no theoretical limitation for the distance between detectors, Gisin⁴ has demonstrated entanglement to seven miles. It follows that this alternate action-at-a-distance phenomenon would also work to that same distance, and probably further.

4) The output of the latch can be fed to the input of another detector so-as-to repeat the signal, sending it double the distance. In fact, any number of repeaters can be used to send the signal any distance.

5) Other technology optic delay switches could also be used.

The orthodox explanation, Copenhagen interpretation according to Wheeler, is that the photons go back in time and revert to going down the right side only when they find the left side blocked by destructive interference. In the gyroverse interpretation, the photons simultaneously travel both paths in sister-locations (see the gyroverse, 2^{nd} edition, page 134). While these sister-locations may be 7 miles apart in three-dimensional space, they are actually 10⁻³⁰ cm apart in the full twelve-dimensional space. When it destructively interferes on the left side, it concentrates on the right side where there is no interference. Time never goes backward.

FIG. 2 is a schematic of the phase splitter. The photons enter the phase splitter from the top (31), and strike the half-silvered mirror (34). Half the light-beam passes through the mirror and through the light funnel (37) which concentrates the light-beam into a fiber cable (38). The other half of the beam bounces off the half-silvered mirror with a phase reversal, then passes through the glass slab, being concentrated by the light funnel (36) into fiber cable (33). If both paths are of equal length passing through an equivalent amount of material, with some adjustment, the beams will enter fiber-optic cable simultaneously, but 180 degrees out of phase.

### CONCLUSION

The argument that restricts quantum entanglement from being used for information exchange is that each set alone is random. Only by comparing both sets does the information being transmitted show through.

A similar argument applies to a single photon taking multiple paths. Since it cannot be predicted which particular path a single photon will take, using this characteristic to transmit information is also problematic.

While it may not be possible to predict which path a particular photon will take, altering the probability of taking each path is possible. As a result, it is possible to predict the path distribution probability for a large number of photons, and use it to communicate much faster than light-speed. In effect, defined is a delayed-choice arrangement, where the alternate paths, L Cable (13), and R Cable (14) happen to terminate, one close to the input, and the other far from it.

On the other hand, if the two cables had terminated near each other, the configuration would have been a miniaturized variation of Wheeler's original Delayed-Choice proposal, and the result would have been expected. However, in the realm of quantum physics spatial separation is not relevant, so that separating the cables will change nothing.

What I claim as my invention is:

1. A Delayed-Choice-EPR arrangement where a beam modifier, redirects the input beam instantly, much faster than the speed of light, to and from the output beam near the distant location.

2. That defined in claim 1, an apparatus comprising:
a) a means for generating a monochromatic light beam;
b) a means for splitting the said light beam by a 1X2 light splitter, directing one part though a fiber optic cable toward the input, and other part through another fiber optic cable, of slightly longer length, toward the distant output;
c) a means for connecting the said input beam to the said beam modifier;
d) a means for enabling the said beam modifier to cause the said input beam to either destructively or constructively interfere with itself;
e) a means at the output end to recognize a difference in light intensity received.

3. That defined in claim 2 where in the said beam modifier arrangement:
a) light is first passed through a phase splitter;
b) one output of the phase splitter is passed directly to one input of the 2X1 combiner;
c) the other output of the said phase splitter is input to an optical delay switch, which then connects to the other said 2X1 combiner input.

4. That defined in claim 2, where circuitry is added at the output detector such that the intensity above a certain value is recognized as a one and below it as a zero.

5. That defined in claim 4, where any number of these arrangements can be cascaded to send information any distance.

6. That defined in claim 4, where there are two such arrangements, facing opposite direction, enabling two-way communication.
